(19) United States
(12) Patent Application Publication
(10) Pub. No.: US 2021/0253072 A1
(43) Pub. Date: Aug. 19, 2021

(54) OPTICAL APPARATUS, ON-VEHICLE SYSTEM INCLUDING THE SAME, AND MOVING APPARATUS

(71) Applicant: CANON KABUSHIKI KAISHA, Tokyo (JP)

(72) Inventor: Masatsugu Nakano, Tochigi (JP)

(21) Appl. No.: 17/165,735

(22) Filed: Feb. 2, 2021

(30) Foreign Application Priority Data
Feb. 13, 2020 (JP) 2020-022216

(51) Int. Cl. B60T 7/22; G02B 26/10; G02B 26/08; B60Q 9/00; G01S 7/481; G01S 17/931; G01S 17/08

(52) U.S. Cl. CPC B60T 7/22; G02B 26/101; G02B 26/0833; B60T 2210/32; G01S 7/4817; G01S 17/931; G01S 17/08; B60Q 9/008

(57) ABSTRACT

An optical apparatus includes a deflection unit configured to deflect illumination light from a light source to scan an object, and deflect reflected light from the object, and a light guide unit configured to guide the illumination light from the light source to the deflection unit and guide the reflected light from the deflection unit to a light receiving element. The light guide unit includes a first optical element to change a diameter of the illumination light from the light source, a second optical element including a passage region through which the illumination light from the first optical element passes and a reflective region to reflect the reflected light from the deflection unit, and at least one fixing member fixing the first optical element and the second optical element to each other.

### BACKGROUND

### Field of the Disclosure

The present disclosure relates to an optical apparatus that receives reflected light from an illuminated object to detect the object.

### Description of the Related Art

A known distance measuring apparatus to measure the distance to an object scans the object by deflecting illumination light from a light source via a deflection unit, and then calculates the distance to the object based on the time duration until receiving reflected light from the object and the phase of the reflected light.

Japanese Patent Application Laid-Open No. 2012-68350 discusses a distance measuring apparatus including a prism that reflects either illumination light or reflected light on the inner surface and that reflects the other on the outer surface to guide the illumination light and the reflected light to a deflection unit and a light receiving element, respectively.

The spreading angle of illumination light emitted from a typical light source used in a distance measuring apparatus is different between the horizontal and the vertical directions. For favorable distance measurement accuracy, the illumination light is shaped. However, it is difficult to shape the illumination light with the prism of which the outer surface is used to reflect the illumination light discussed in Japanese Patent Application Laid-Open No. 2012-68350.

On the other hand, while it is possible to shape the illumination light with the prism of which the inner surface is used to reflect the illumination light discussed in Japanese Patent Application Laid-Open No. 2012-68350, it is very difficult to form both a transmissive region and a reflective region on the outer surface of the prism in a complicated shape.

### SUMMARY

The present disclosure is directed to providing an optical apparatus that is easily produced and that shapes illumination light well.

According to an aspect of the present invention, an optical apparatus includes a deflection unit configured to deflect illumination light from a light source to scan an object, and deflect reflected light from the object, and a light guide unit configured to guide the illumination light from the light source to the deflection unit and guide the reflected light from the deflection unit to a light receiving element. The light guide unit includes a first optical element to change a diameter of the illumination light from the light source, a second optical element including a passage region through which the illumination light from the first optical element passes and a reflective region to reflect the reflected light from the deflection unit, and at least one fixing member fixing the first optical element and the second optical element to each other.

Further features of the present invention will become apparent from the following description of exemplary embodiments with reference to the attached drawings.

### BRIEF DESCRIPTION OF THE DRAWINGS

FIG. 1 schematically illustrates the main portion of an optical apparatus according to a first exemplary embodiment.

FIGS. 2A and 2B illustrate optical paths of illumination light and reflected light, respectively, in the optical apparatus according to the first exemplary embodiment.

FIG. 3 schematically illustrates a general semiconductor laser device.

FIGS. 4A and 4B schematically illustrate the main portion of a light guide unit according to the first exemplary embodiment.

FIG. 5 illustrates a relationship between angle of incidence and reflectance of P polarized light with the light guide unit according to the first exemplary embodiment.

FIG. 6 schematically illustrates the main portion of an optical apparatus according to a second exemplary embodiment.

FIGS. 7A and 7B schematically illustrate the main portion of a light guide unit according to the second exemplary embodiment.

FIG. 8 schematically illustrates the main portion of an optical apparatus according to a third exemplary embodiment.

FIGS. 9A and 9B schematically illustrate the main portion of a light guide unit according to the third exemplary embodiment.

FIG. 10 schematically illustrates the main portion of an optical apparatus according to a fourth exemplary embodiment.

FIGS. 11A and 11B schematically illustrate the main portion of a light guide unit according to a fifth exemplary embodiment.

FIG. 12 illustrates a functional block diagram of an on-vehicle system according to another exemplary embodiment.

FIG. 13 schematically illustrates a vehicle (moving apparatus) according to the present exemplary embodiment.

FIG. 14 is a flowchart illustrating an operation example of the on-vehicle system according to the present exemplary embodiment.

### DESCRIPTION OF THE EMBODIMENTS

Exemplary embodiments of the present invention will be described below with reference to the accompanying drawings. For descriptive purposes, each drawing may be illustrated in a scale different from the actual scale. In each drawing, like numbers refer to like members, and redundant descriptions thereof will be omitted.

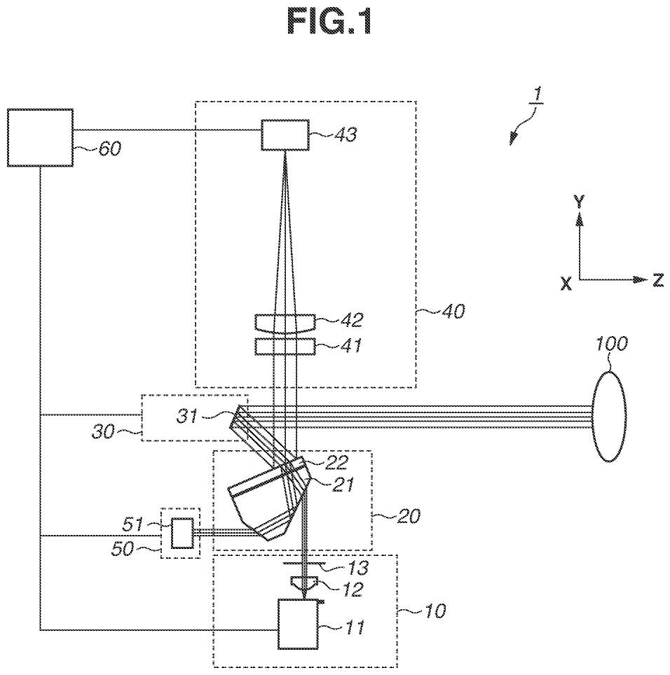

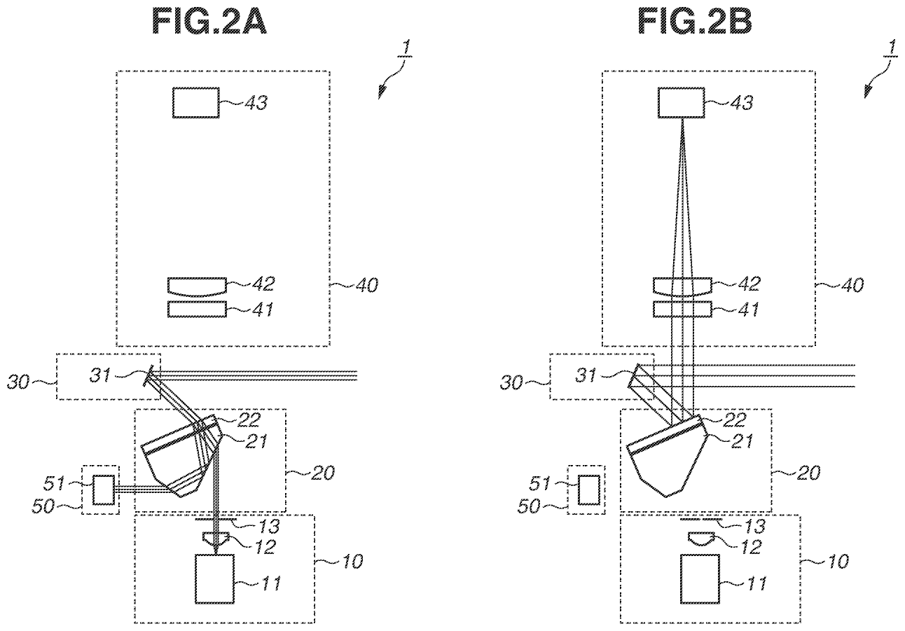

FIG. 1 schematically illustrates the main portion of an optical apparatus 1 in a cross-section including the optical axis (YZ cross-section), according to a first exemplary embodiment of the present invention. The optical apparatus 1 includes a light source unit 10, a light guide unit (splitting unit) 20, a deflection unit 30, a light receiving unit (first light receiving unit) 40, a light receiving unit for light source (second light receiving unit) 50, and a control unit 60. FIGS. 2A and 2B illustrate optical paths in the optical apparatus 1. FIG. 2A illustrates an optical path (illumination optical path) along which illumination light from the light source unit 10 travels toward an object 100, and FIG. 2B illustrates an optical path (light receiving optical path) along which reflected light from the object 100 travels toward the light receiving unit 40.

The optical apparatus 1 serves as a detection apparatus (imaging apparatus) to detect (capture) the object 100 or as a distance measuring apparatus to acquire the distance (distance information) to the object 100 by receiving reflected light from the object 100. The optical apparatus 1 according to the present exemplary embodiment employs a technique called Light Detection And Ranging (LiDAR) to calculate the distance to the object 100 based on the time duration until the optical apparatus 1 receives reflected light from the object 100 and the phase of the reflected light.

The light source unit 10 includes a light source 11, an optical element 12, and a diaphragm 13. The light source 11 may be a semiconductor laser device with a high energy concentration and directivity. The object 100 may include a human body, for example, with the optical apparatus 1 in an on-vehicle system (described below). The light source 11 therefore emits infrared light, which has a little influence on the human eyes. The illumination light emitted by the light source 11 according to the present exemplary embodiment has a wavelength of 905 nm, which is in the near-infrared region.

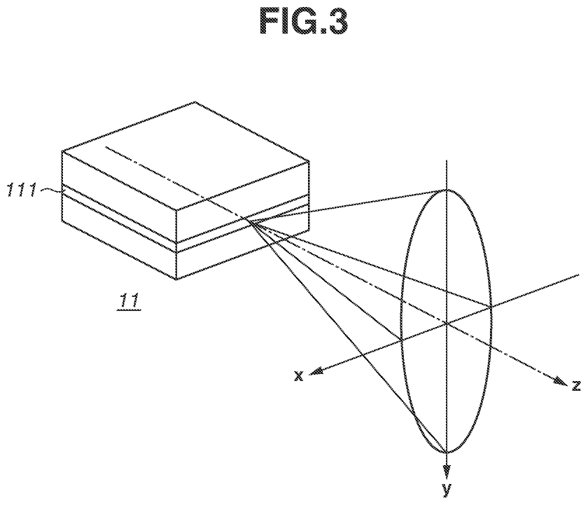

FIG. 3 schematically illustrates a general semiconductor laser device and a light beam emitted therefrom. As illustrated in FIG. 3, the active layer 111 of the semiconductor laser device as the light source 11 emits a divergent light beam in an elliptic shape in the xy cross-section parallel to the light emitting surface of the active layer 111. If the semiconductor laser 11 is a linearly polarized light type, the polarization direction of the light beam (the oscillation direction of the electric field) is parallel to the upper and lower surfaces of the active layer 111, i.e., in directions in the zx cross-section.

The optical element 12 has a function of changing the convergence of illumination light emitted from the light source 11. The optical element 12 according to the present exemplary embodiment is a collimator lens (collective element) that changes (collimates) the divergent light beam emitted from the light source 11 into a parallel light beam. The parallel light beam in this case includes not only a strict parallel light beam but also an approximate parallel light beam such as a weakly divergent light beam and a weakly convergent light beam.

The diaphragm 13, a light-shielding member provided with an opening, determines the light beam diameter (light beam width) by narrowing illumination light from the optical element 12. The opening shape of the diaphragm 13 according to the present exemplary embodiment is an ellipse corresponding to the shape of the illumination light. However, the opening shape is not limited thereto but may be other than an ellipse. The opening diameter of the diaphragm 13 according to the present exemplary embodiment is 1.50 mm in the X-axis direction (major axis direction) and 0.75 mm in the Z-axis direction (minor axis direction).

The light guide unit 20 is a light guide member to form an illumination optical path and a light receiving optical path, as illustrated in FIGS. 2A and 2B, respectively. The light guide unit 20 guides illumination light from the light source unit 10 to the deflection unit 30, and guides reflected light from the deflection unit 30 to the light receiving unit 40. The light guide unit 20 includes a prism (first optical element) 21 and a splitting element (second optical element) 22. The prism 21 changes the diameter of illumination light from the light source unit 10. The splitting element 22 includes a passage region 2221 through which the illumination light from the prism 21 passes, and a reflective region 2222 that reflects reflected light from the deflection unit 30.

The materials of the prism 21 and the splitting element 22 each have a sufficiently high transmissivity with respect to the wavelength of the illumination light. More specifically, the materials each has a refractive index of 1.70 or higher with respect to the 905 nm wavelength. The materials of the prism 21 and the splitting element 22 according to the present exemplary embodiment each are S-LAH92 provided by OHARA Inc., with a refractive index of 1.871 with respect to the 905 nm wavelength. The materials of the prism 21 and the splitting element 22 may be different from each other.

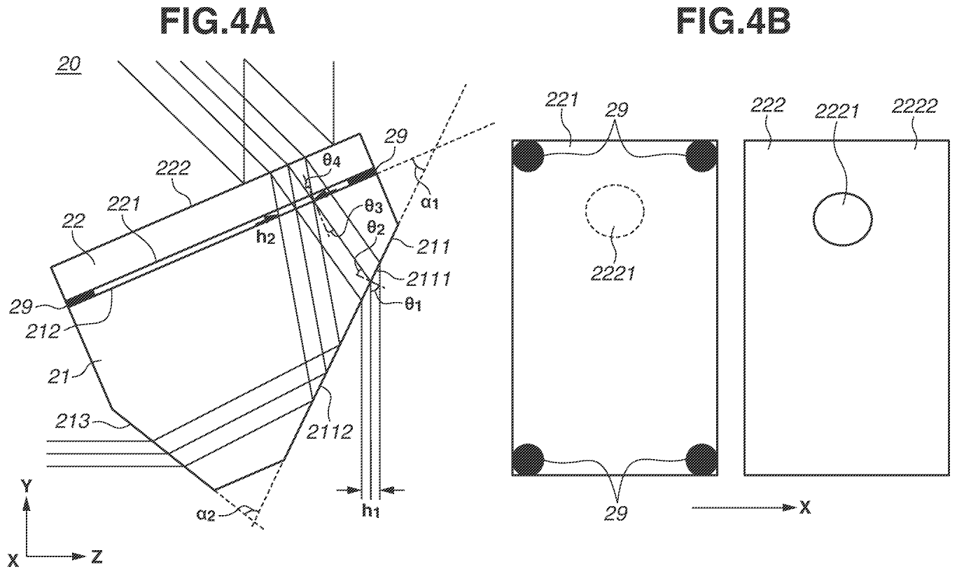

FIGS. 4A and 4B schematically illustrate the main portion of the light guide unit 20 according to the present exemplary embodiment. The prism 21 and the splitting element 22 each have a plurality of optical surfaces to transmit and reflect light beams. More specifically, the prism 21 has a first surface 211, a second surface 212, and a third surface 213, and the splitting element 22 has a first surface 221 and a second surface 222. FIG. 4A illustrates a cross-section (YZ cross-section) perpendicular to each optical surface of the light guide unit 20, and FIG. 4B illustrates the first surface 221 and the second surface 222 of the splitting element 22 viewed from the normal direction. According to the present exemplary embodiment, in the YZ cross-section, the angle α₁ formed between the first surface 211 and the second surface 212 of the prism 21 is 41.0 degrees, and the angle α₂ formed between the first surface 211 and the third surface 213 of the prism 21 is 78.4 degrees.

The first surface 211 of the prism 21 is an optical surface (light incident surface) on which illumination light from the light source unit 10 is incident, and the second surface 212 of the prism 21 is an optical surface (light emitting surface) from which the illumination light from the first surface 211 is emitted. As described above, since the opening of the diaphragm 13 is in an ellipse, which forms a light incident region (passage region) 2111 of the illumination light on the first surface 211 in an ellipse. The first surface 211 includes a total reflective region 2112 in the region other than the light incident region 2111 of illumination light from the light source unit 10. The total reflective region 2112 totally reflects the light reflected by the second surface 212 of the prism 21 and each optical surface of the splitting element 22 to guide the light to the third surface 213 of the prism 21. An antireflection film may be provided to the light incident region 2111 to reduce the reflectance to improve the transmissivity, and a reflection film to the total reflective region 2112.

The first surface 221 of the splitting element 22 is an optical surface (light incident surface) on which the illumination light from the second surface 212 of the prism 21 is incident. The second surface 222 of the splitting element 22 is an optical surface (a light emitting surface and a reflection surface) with the passage region 2221 that transmits the illumination light from the first surface 221 and the reflective region 2222 that reflects reflected light from the deflection unit 30. The passage region 2221 according to the present exemplary embodiment is a transmissive region to transmit the illumination light in an elliptic shape. However, the configuration is not limited thereto.

For example, the splitting element 22 may be provided with a hole to be used as the passage region 2221. If the light guide unit 20 shapes the illumination light so that its cross-section has a shape other than an ellipse (for example, a circle), the passage region 2221 may accordingly have a shape other than an ellipse (for example, a circle). The passage region 2221 may be provided with an antireflection film. The reflective region 2222 according to the present exemplary embodiment is provided with a metal or dielectric reflection film (reflection layer). At the bottom portion (bottom layer) of the reflection film is provided an absorption layer to absorb the light from the prism 21.

Illumination light that has passed through the opening of the diaphragm 13 enters the prism 21 from the first surface 211 of the prism 21, penetrates the second surface 212, and travels to the splitting element 22. As described above, the present exemplary embodiment is configured to allow the illumination light to enter the prism 21 and then guide the light to the deflection unit 30. This makes it possible to shape the illumination light by the refractive action at the first surface 211 and the second surface 212, which are non-parallel to each other. Thus, even if the spreading angle (divergent angle) of the illumination light from the light source unit 10 is different between the X- and the Z-directions, the optical apparatus 1 provides a favorable distance measurement accuracy (detection accuracy).

The following assumes a case where the illumination light does not penetrate the prism 21 but reflects off the outer surface of the prism 21, and then is guided to the deflection unit 30. In this case, illumination light from the light source unit 10 travels to the deflection unit 30 only via the outer surface of the prism 21. Under the condition, to shape the illumination light, the outer surface of the prism 21 is an aspherical (anamorphic) surface. In this configuration, reflected light from the object 100 is also incident on the outer surface, in which the aspherical surface affects the reflected light, making it difficult to obtain a favorable distance measurement accuracy.

Alternatively, there is a conceivable method of shaping the illumination light by placing another optical element in the illumination light path between the light guide unit 20 and the deflection unit 30. However, this method leads to an increase in the number of parts in the optical apparatus 1, resulting in increase in the complexity and size of the entire apparatus and increase in the difficulty in assembly and adjustment of the apparatus. Thus, to obtain a favorable distance measurement accuracy and to achieve simplicity and compactness of the optical apparatus 1 simultaneously, the illumination light enters the prism 21 and is guided to the deflection unit 30 via a plurality of optical surfaces of the prism 21 as in the present exemplary embodiment.

In the present exemplary embodiment, the illumination light that has entered the prism 21 from the first surface 211 is directly guided to the second surface 212, without travelling via the other surfaces. This configuration enables shaping the illumination light by using a minimum number of optical surfaces of the prism 21, i.e., only via the first surface 211 and the second surface 212. This reduces the possibility that partial illumination light is scattered by scratches and foreign matter on an optical surface, generating undesirable light that will enter the splitting element 22.

According to the present exemplary embodiment, the light guide unit 20 includes a plurality of optical elements. More specifically, the light guide unit 20 is composed of the prism 21 to change the diameter of the illumination light, and the splitting element 22 to guide the illumination light to the deflection unit 30 and to guide reflected light from the deflection unit 30 to the light receiving unit 40. As described above, the first surface 211 and the second surface 212 of the prism 21 are non-parallel to each other to change the diameter of the illumination light. It is very difficult to provide a passage region and a reflective region with high accuracy on the outer surface of the prism 21 in such a complicated shape.

On the other hand, the splitting element 22, which does not change the diameter of the illumination light, can be formed in a simple shape such as a parallel plate. The first surface 221 and the second surface 222 of the splitting element 22 according to the present exemplary embodiment are parallel to each other, and the splitting element 22 is a flat plate. A passage region and a reflective region can be easily be provided to the outer surface of the splitting element in such a simple shape with high accuracy. In addition, a plurality of splitting elements 22 can easily be produced simultaneously. For example, the production cost can be reduced by providing a passage region and a reflective region on a basal plate and cutting out a plurality of splitting elements 22 from the basal plate.

Further, the prism 21 and the splitting element 22 according to the present exemplary embodiment are “fixed to” each other (integrally held) by fixing members 29. The prism 21 and the splitting element 22 that are fixed to each other allows higher accurate positioning of the prism 21 and the splitting element 22 in installation of the light guide unit 20 in the production process of the optical apparatus 1. Further, this configuration reduces displacement of individual members due to vibration or shock. According to the present exemplary embodiment, the second surface 212 of the prism 21 and the first surface 221 of the splitting element 22 are bonded by the fixing members 29 as a bonding member (adhesive agent), but the configuration of the fixing members 29 is not limited thereto.

For example, the prism 21 and the splitting element 22 may be bonded to each other with a bonding agent applied to the outer surfaces of the two members, or may be fixed with the outer surfaces of the two members pinched simultaneously with a pinching member. For repair and maintenance of the light guide unit 20, the prism 21 and the splitting element 22 may be separably fixed to each other. In addition, the prism 21 and the splitting element 22 may be fixed to each other so that the relative position between the two members is variable. For example, the prism 21 and the splitting element 22 may be fixed to each other by using a housing member that can house both the prism 21 and the splitting element 22 or a bonding member whose shape is variable (e.g., elastic bonding member).

The fixing members 29 fix the prism 21 and the splitting element 22 outside the passage region of the illumination light. If the fixing members 29 are located partly or entirely in or over the passage region of the illumination light, the optical apparatus 1 may have worse optical performances because of changed properties of the fixing members 29 with environmental variation (temperature and humidity variations) or over time. For example, if the fixing members 29 as bonding members become clouded with environmental variation or over time, the object 100 can be insufficiently illuminated due to decrease in transmittance of the fixing members 29 and/or diffusion of partial illumination light in the fixing members 29. Besides, illumination light that diffuses in the fixing members 29 (undesirable light) can enter the light receiving unit 40.

As described above, providing the fixing members 29 on a region other than the passage region 2221 of the illumination light enables preventing the optical performances from being affected by property variations of the fixing members 29. In the present exemplary embodiment, as illustrated in FIG. 4B, the fixing members 29 are provided at locations other than the passage region 2221 of the illumination light on the first surface 221 of the splitting element 22, more specifically, at the four corners of the first surface 221. The arrangement of the fixing members 29 is not limited to the arrangement illustrated in FIG. 4B as long as the fixing members 29 are provided at portions other than the passage region 2221 of the illumination light. However, to stably fix the prism 21 and the splitting element 22, the fixing members 29 are provided at at least three locations on the first surface 221. To more stability, the fixing members 29 are provided at four locations on the first surface 221 as in the preferred exemplary embodiment.

Bonding the prism 21 and the splitting element 22 to locations outside the passage region 2221 of the illumination light creates a gap (clearance) between the second surface 212 of the prism 21 and the first surface 221 of the splitting element 22 in the passage region of the illumination light. To downsize the light guide unit 20 and improve light utilization efficiency, the distance between the second surface 212 and the first surface 221 is minimized More specifically, the light guide unit 20 satisfies the following conditional expression (1):

t<1.0 mm (1)

where t is the distance between the prism 21 and the splitting element 22, i.e., the distance between the second surface 212 and the first surface 221.

If the distance t exceeds the upper limit represented by the conditional expression (1), the light guide unit 20 can increase in size, and/or light utilization efficiency of the guide unit 20 can decrease due to unintended reflection or a lower quantity of illumination light between the second surface 212 and the first surface 221. According to the present exemplary embodiment, the distance is t=8 μm, satisfying the conditional expression (1). Further, for more decrease in size of the light guide unit 20 and/or more reduction of the decrease in light utilization efficiency of the light guide unit 20, the following conditional expressions (1a) and (1b) are satisfied in this order:

t<0.1 mm (1a)

t<0.05 mm (1b)

The on-vehicle system (described below) detects, as the object 100, an object existing in a range from approximately 1 m (short distance) to approximately 300 m (long distance) from the optical apparatus 1. However, the intensity of reflected light (signal light) from the object 100 decreases as the distance from the optical apparatus 1 to the object 100 increases. For example, if the distance from the optical apparatus 1 to the object 100 increases by 10 times, the intensity of the reflection light received by the optical apparatus 1 decreases by approximately 1/100 times.

The measurement of the distance of the object 100, especially at a long distance, can be significantly affected in accuracy by undesirable light as described above. For example, a high ratio of the undesirable light to the signal light received by the light receiving unit 40 hinders distinction between the signal light and the undesirable signal, resulting in a large decrease in the distance measurement accuracy. On one hand, there is a conceivable method of increasing the quantity of the illumination light (the output of the light source 11) with the increase in the distance to the object 100, resulting in increasing influence of the object 100 on the human eyes.

On the other hand, the optical apparatus 1 with a simple configuration according to the present exemplary embodiment reduces the occurrence of undesirable light without increasing the quantity of the illumination light, thus providing a favorable distance measurement accuracy. In addition to that, the optical apparatus 1 according to the present exemplary embodiment can acquire distance information on the object 100 with high accuracy even with, as the light receiving unit 40, an infrared sensor that has a lower sensitivity than a visible light sensor.

As described above, the prism 21 is configured to change (vary) the diameter of illumination light from the light source unit 10. In the present exemplary embodiment, the diameter of the illumination light in the YZ cross-section is enlarged by refraction when the illumination light passes through the first surface 211 and the second surface 212. More specifically, in the YZ cross-section, the diameter of the illumination light emitted from the passage region 2221 is larger than the diameter of the illumination light incident on the first surface 211.

The spreading angle of the illumination light can thus be reduced by the diameter of the illumination light increasing, providing sufficient illuminance and resolving power even if the object 100 exists at a distant place. In the present exemplary embodiment, only the light beam diameter in the YZ cross-section is enlarged according to the elliptic illumination light from the light source unit 10, but the method is not limited to this configuration. The light beam diameter may be reduced in the YZ cross-section or varied in a cross-section perpendicular to the YZ cross-section, depending on the shape of the illumination light and given detection information.

when, in the YZ cross-section, the diameter (the diameter of diaphragm 13) of the illumination light incident on the first surface 211 of the prism 21 is denoted by h₁, the diameter of the illumination light emitted from the second surface 212 of the prism 21 by h₂, the angle of incidence of the illumination light with respect to the first surface 211 of the prism 21 by θ₁ degrees, and the angle of refraction of the illumination light with respect to the first surface 211 by θ₂ degrees, the angle of incidence of the illumination light with respect to the second surface 212 of the prism 21 by θ₃ degrees, and the angle of refraction of the illumination light with respect to the second surface 212 by θ₄ degrees, based on Snell's law, the following relationship represented by the expression (2) holds:

h₂/h₁=(cos θ₂*cos θ₄)/(cos θ₁*cos θ₃) (2)

The values of both sides of expression (2) are greater than 1 when the angle of incidence θ₁ with respect to the first surface 211 of the prism 21 is larger than the angle of refraction θ₄ with respect to the second surface 212 of the prism 21. This means that, when the values of both sides of expression (2) are greater than 1, the diameter of the illumination light is enlarged by the prism 21. In the present exemplary embodiment, h₁=0.75 mm, h₂=1.425 mm, 01=64.3 degrees, 02=28.8 degrees, θ₃=12.2 degrees, and θ₄=23.3 degrees, and the values of both sides of expression (2) are 1.90, which indicates that the diameter of the illumination light is enlarged.

The deflection unit 30 is a member to deflect illumination light from the light guide unit 20 to scan the object 100 and to deflect reflected light from the object 100 to guide the reflected light to the light guide unit 20. The deflection unit 30 according to the present exemplary embodiment includes a single drive mirror (movable mirror) 31. The drive mirror 31 is swingable around at least two axes (2-axis drive mirror) to enable two-dimensionally scanning the object 100. For example, a galvanometer mirror or a Micro Electro Mechanical System (MEMS) mirror can be employed as the drive mirror 31. The drive mirror 31 according to the present exemplary embodiment is a MEMS mirror with a swinging angle of ±15 degrees around the X- and the Y-axes and a swinging frequency of 1 kHz.

The light receiving unit (light receiving unit for distance measurement) 40 includes an optical filter 41, an optical element 42, and a light receiving element (light receiving element for distance measurement) 43. The optical filter 41 is a member to transmit only desired light and to block (absorbing) the other undesirable light. The optical filter 41 according to the present exemplary embodiment is a band-pass filter to transmit only the light in the wavelength band corresponding to the illumination light emitted from the light source 11. The optical element 42 is a condenser lens to condense the light that has passed through the optical filter 41 on the light receiving surface of the light receiving element 43. The configurations of the optical filter 41 and the optical element 42 are not limited to those according to the present exemplary embodiment. For example, the two members may be disposed in the reverse order, and a plurality of optical filters 41 and a plurality of optical elements 42 may be disposed.

The light receiving element (first light receiving element) 43 is an element (sensor) to receive light from the optical element 42, to photoelectrically convert the light into a signal, and to output the signal. The light receiving element 43 composed of a Photo Diode (PD), an Avalanche Photo Diode (APD), or a Single Photon Avalanche Diode (SPAD) can be employed. Light reflected from the object 100 illuminated by the illumination light is deflected by the deflection unit 30 and reflects off the reflective region 2222 of the splitting element 22, and then enters the light receiving element 43 through the optical filter 41 and the optical element 42.

Partial illumination light from the first surface 211 of the prism 21 does not penetrate but reflects off the second surface 212 of the prism 21 and each optical surface of the splitting element 22. This reflection occurs regardless of the presence or absence of an antireflection film in the passage region 2221. FIG. 4A illustrates only the light reflecting off the passage region 2221 of the splitting element 22. The light that reflects off the passage region 2221 totally reflects off the total reflective region 2112 on the first surface 211 of the prism 21, exits from the third surface 213 of the prism 21, and then enters the light receiving unit for light source 50.

The light receiving unit for light source 50 includes a light receiving element for light source (second light receiving element) 51 to photoelectrically convert illumination light from the light source 11 into a signal and then output the signal. For example, a sensor similar to the light receiving element 43 may be used as the light receiving element for light source 51. The light receiving unit for light source 50 may include an optical element (filter or lens) to guide light from the prism 21 to the light receiving surface of the light receiving element for light source 51.

The control unit 60 controls the light source 11, the drive mirror 31, the light receiving element 43, and the light receiving element for light source 51. The control unit 60 is, for example, a processing unit (processor) such as a Central Processing Unit (CPU) or a calculation unit (computer) including the processing unit. The control unit 60 drives the light source 11 and the drive mirror 31 individually with predetermined drive voltages and predetermined drive frequencies, and controls the output of the light source 11 (the quantity of illumination light) based on the signal from the light receiving element for light source 51. For example, the control unit 60 controls the light source 11 to change illumination light to pulsed light, and performs intensity modulation on illumination light to generate signal light.

The control unit 60 can acquire distance information on the object 100 based on the time period since the time (illumination time) when illumination light is emitted from the light source 11 until the time (light receiving time) when the light receiving element 43 receives reflected light from the object 100. In this case, the control unit 60 may acquire signals from the light receiving element 43 at a specific frequency. The control unit 60 may acquire the distance information based not on the time duration until reflected light from the object 100 is received but on the phase of reflected light from the object 100. More specifically, the control unit 60 may find the difference (phase difference) between the signal phase of the light source 11 and the signal phase output from the light receiving element 43, and then multiply the phase difference by the velocity of light to acquire the distance information on the object 100.

The optical apparatus 1 as a LiDAR-based distance measuring apparatus identifies the object 100 such as a vehicle, a passenger, or an obstacle, and is suitable for an on-vehicle system that controls the vehicle provided with the on-vehicle system based on the distance information on the object 100. LiDAR can be compatible with a coaxial system or a non-coaxial system. In the coaxial system, the optical axes of the light source unit 10 and the light receiving unit 40 partially coincide with each other. In the non-coaxial system, the optical axes do not coincide with each other. The optical apparatus 1 according to the present exemplary embodiment includes the light guide unit 20 to downsize the entire apparatus with a coaxial system.

In the present exemplary embodiment, the traveling direction of the illumination light incident on the incident region 2111 is parallel to the traveling direction of the reflected light reflected by the reflective region 2222, which means that the traveling directions are parallel to the Y-direction. More specifically, the light source unit 10 and the light receiving unit 40 according to the present exemplary embodiment are disposed so that the respective optical axes are parallel to each other. This arrangement achieves the downsizing of the apparatus.

The light source 11 is disposed so that the x axis illustrated in FIG. 3 coincides with the Z axis illustrated in FIG. 1, and the y axis illustrated in FIG. 3 coincides with the X axis illustrated in FIG. 1. The disposition of the light source 11 enables changing the illumination light incident on the incident region 2111 of the first surface 211 to P polarized light of which the electric field oscillates in the YZ cross-section.

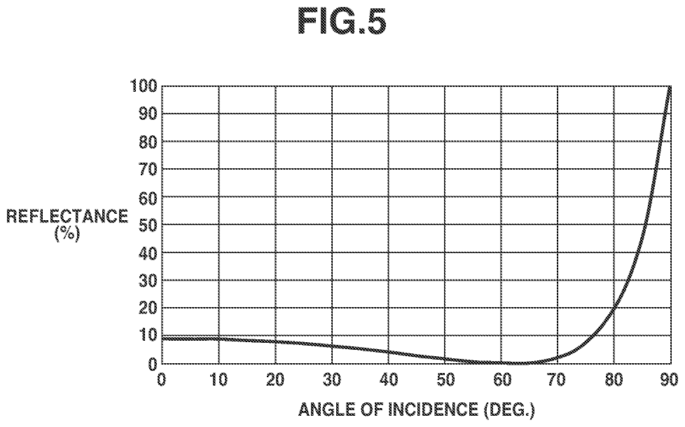

FIG. 5 illustrates the relationship between the angle of incidence and the reflectance of the P polarized light with respect to the first surface 211 according to the present exemplary embodiment. The reflectance of the P polarized light with respect to the first surface 211 decreases as the angle of incidence with respect to the first surface 211 increases from 0 degree. The reflectance once reaches 0 and then increases. The angle of incidence at a reflectance of the P polarized light of 0 is referred to as a Brewster's angle. A Brewster's angle θ_{B} is represented by following expression (3):

θ_{B}=tan⁻¹(N′/N) (3)

where N is the refractive index to the incident medium of the P polarized light, and N′ is the refractive index to the light emitting medium.

Making the illumination light incident at an angle of incidence close to the Brewster's angle θ_{B} with respect to the first surface 211 allows the reflectance of the light incident region 2111 on the first surface 211 to be reduced without using an antireflection film. This enables the illumination light to enter the prism 21 with a high efficiency in a simple configuration. In this case, the prism 21 satisfies the following conditional expression (4):

−10<θ_{B}−θ₁<10 (4)

According to the present exemplary embodiment, the Brewster's angle for the material of the prism 21 is 61.9 degrees, resulting in θ_{B}−θ₁=−2.4 degrees, which satisfies the conditional expression (4). Further, to obtain lower values of reflectance, the following conditional expressions (4a) and (4b) are satisfied in this order:

−8.5<θ_{B}−θ₁<8.5 (4a)

−7.5<θ_{B}−θ₁<7.5 (4b)

The optical apparatus 1 according to the present exemplary embodiment enables facilitating the production and favorably shaping the illumination light.

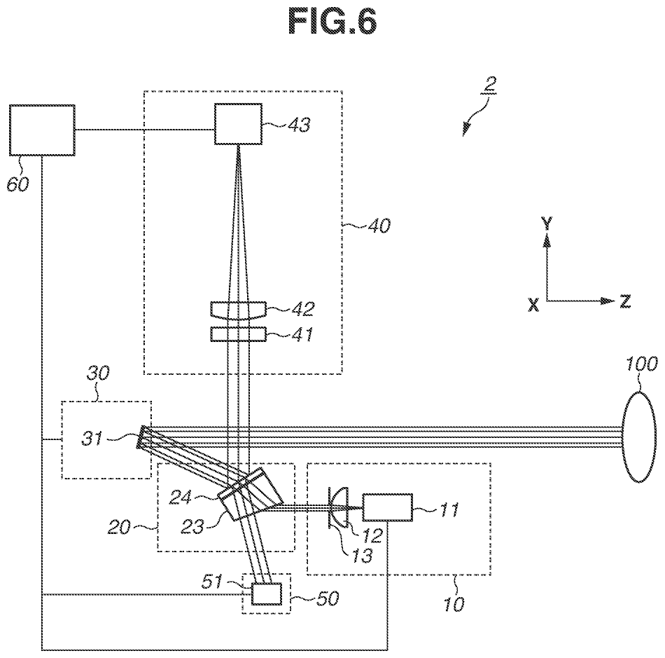

A second exemplary embodiment will be described. FIG. 6 schematically illustrates the main portion of an optical apparatus 2 in a cross-section (YZ cross-section) with the optical axis of the optical apparatus 2 according to the second exemplary embodiment of the present invention. The optical apparatus 2 according to the present exemplary embodiment differs from the optical apparatus 1 according to the first exemplary embodiment in configuration of the light guide unit 20, disposition of the light source unit 10, and disposition of the light receiving unit for light source 50. The other configurations are similar to those of the optical apparatus 1 according to the first exemplary embodiment, and redundant descriptions thereof will be omitted.

The light guide unit 20 according to the present exemplary embodiment includes a prism 23, a splitting element 24, and the fixing members 29, which fixes the two members. The prism 23 and the splitting element 24 are different in shape from those according to the first exemplary embodiment. The prism 23 and the splitting element 24 according to the present exemplary embodiment are made of TAFD55 provided by HOYA Corporation, whose refractive index is 1.972 with respect to the 905 nm wavelength. The optical apparatus 2 according to the present exemplary embodiment differs from the optical apparatus 1 according to the first exemplary embodiment in that the traveling direction (Z-direction) of illumination light entering the light guide unit 20 from the light source unit 10 is perpendicular to the traveling direction (Y-direction) of the light reflected by the light guide unit 20. More specifically, the light source unit 10 and the light receiving unit 40 according to the present exemplary embodiment are disposed so that the respective optical axes are perpendicular to each other.

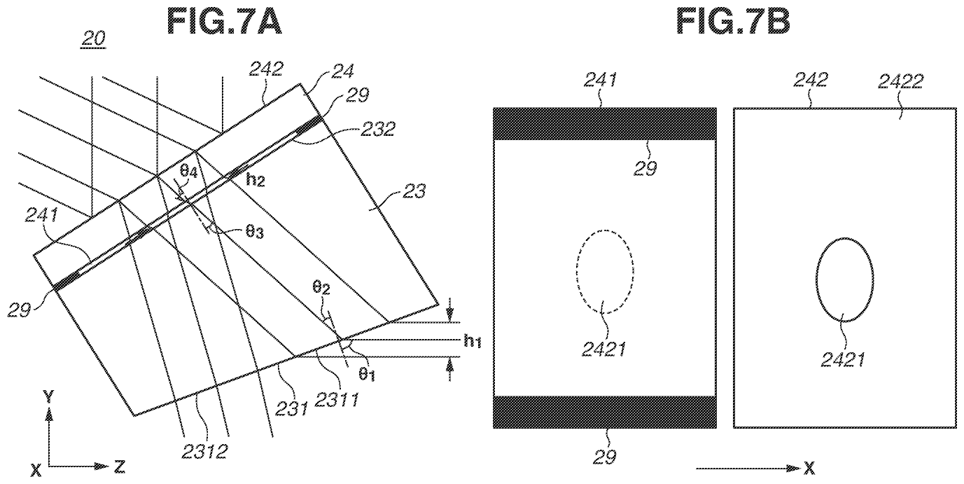

FIGS. 7A and 7B schematically illustrate the main portion of the light guide unit 20 according to the present exemplary embodiment. FIG. 7A illustrates the cross-section (YZ cross-section) perpendicular to each optical surface of the light guide unit 20, and FIG. 7B illustrates the first surface 241 and the second surface 242 of the splitting element 24 viewed from the normal direction. According to the present exemplary embodiment, the angle α₁ (not illustrated) formed between the first surface 231 and the second surface 232 of the prism 23 is 12.7 degrees in the YZ cross-section.

The prism 23 and the splitting element 24 are bonded to each other via the fixing members 29 provided between the second surface 232 of the prism 23 and the first surface 241 of the splitting element 24. According to the present exemplary embodiment, as illustrated in FIG. 7B, the fixing members 29 are provided at locations other than the passage region 2421 of the illumination light on the first surface 241 of the splitting element 24, i.e., at both longitudinal ends of the first surface 241.

Illumination light that has passed through the opening of the diaphragm 13 enters the prism 23 from the first surface 231, penetrates the second surface 232 without traveling via the other surfaces, and travels to the deflection unit 30 through the passage region 2421 of the splitting element 24. According to the present exemplary embodiment, h₁=1.00 mm, h₂=2.27 mm, θ₁=70.2 degrees, θ₂=28.5 degrees, θ₃=15.8 degrees, and θ₄=32.5 degrees, and the values of both sides of expression (2) are 2.27. Thus, the diameter of the illumination light is enlarged by the first surface 231 and the second surface 232 of the prism 23. According to the present exemplary embodiment, the Brewster's angle for the material of the prism 23 is 63.1 degrees, resulting in θ_{B}−θ₁=−7.1 degrees, which satisfies the conditional expression (4).

Partial illumination light from the first surface 231 of the prism 23 does not penetrate but reflects off the second surface 232 of the prism 23 and each optical surface of the splitting element 24. FIG. 7A illustrates only the light reflected by the passage region 2421 of the splitting element 24. The light that has reflected off the passage region 2421 penetrates the first surface 231 of the prism 23, exits from the prism 23, and then enters the light receiving unit for light source 50. The prism 23 according to the present exemplary embodiment is not provided with a third surface that guides the reflected light to the light receiving unit for light source 50, unlike the prism 21 according to the first exemplary embodiment. Thus, the prism 23 can be produced in an easier way (with lower cost) than the prism 21.

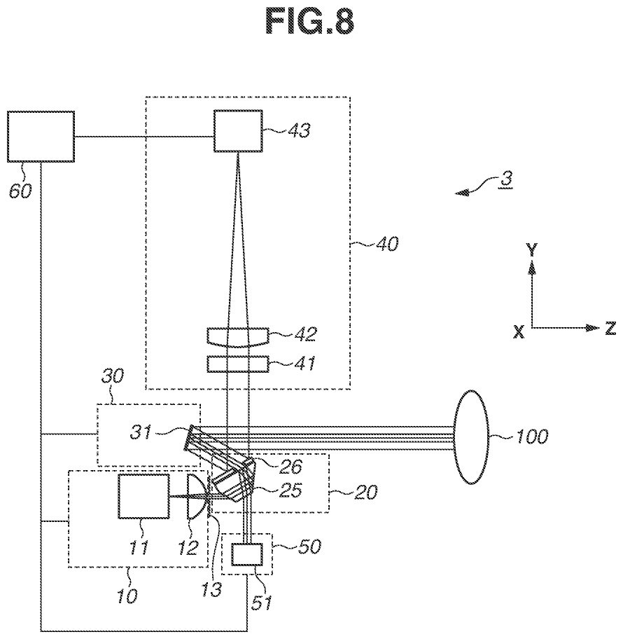

A third exemplary embodiment will be described. FIG. 8 schematically illustrates the main portion of an optical apparatus 3 in a cross-section (YZ cross-section) with the optical axis of the optical apparatus 3 according to the third exemplary embodiment of the present invention. The optical apparatus 3 according to the present exemplary embodiment differs from the optical apparatus 1 according to the first exemplary embodiment in configuration of the light guide unit 20, disposition of the light source unit 10, and disposition of the light receiving unit for light source 50. The other configurations are similar to those of the optical apparatus 1 according to the first exemplary embodiment, and redundant descriptions thereof will be omitted.

The light guide unit 20 according to the present exemplary embodiment includes a prism 25, a splitting element 26, and the fixing members 29, which fixes the two members. The prism 25 and the splitting element 26 are different in shape from those according to the first exemplary embodiment. The prism 25 and the splitting element 26 according to the present exemplary embodiment are made of N-SF11 provided by SchottAG, whose refractive index of 1.759 with respect to the 905 nm wavelength. The optical apparatus 3 according to the present exemplary embodiment is similar to the optical apparatus 2 according to the second exemplary embodiment in that the traveling direction (Z-direction) of illumination light entering the light guide unit 20 from the light source unit 10 is perpendicular to the traveling direction (Y-direction) of the light reflected by the light guide unit 20.

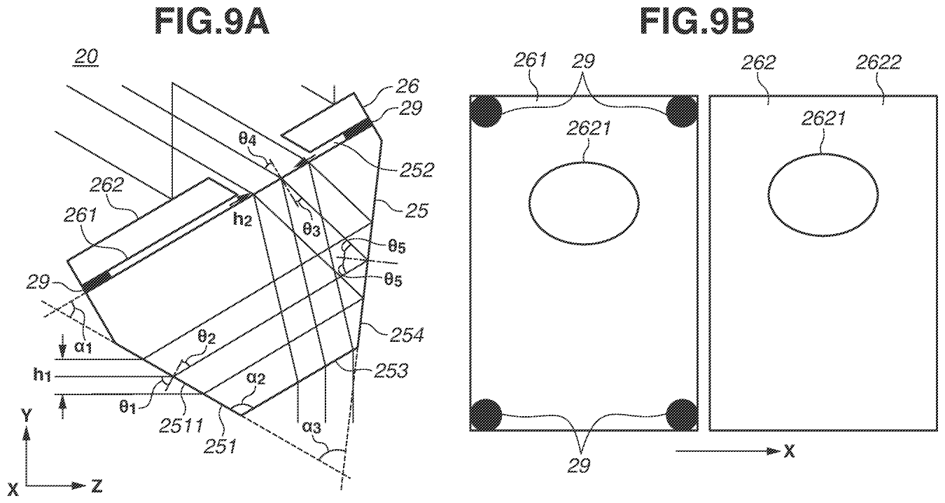

FIGS. 9A and 9B schematically illustrate the main portion of the light guide unit 20 according to the present exemplary embodiment. FIG. 9A illustrates the cross-section (YZ cross-section) perpendicular to each optical surface of the light guide unit 20, and FIG. 9B illustrates the first surface 261 and the second surface 262 of the splitting element 26 viewed from the normal direction. The splitting element 26 according to the present exemplary embodiment is provided with a hole 2621 as a passage region through which illumination light emitted from the prism 25 passes. In the prism 25 according to the present exemplary embodiment, in the YZ cross-section, the angle α₁ formed between a first surface 251 and a second surface 252 is 60.0 degrees, the angle α₂ formed between the first surface 251 and a third surface 253 is 120.0 degrees, and the angle α₃ formed between the first surface 251 and a fourth surface 254 is 66.49 degrees.

The prism 25 and the splitting element 26 are bonded to each other via the fixing members 29 provided between the second surface 252 of the prism 25 and the first surface 261 of the splitting element 26. According to the present exemplary embodiment, as illustrated in FIG. 9B, the fixing members 29 are provided at locations other than the passage region 2621 for the illumination light on the first surface 261 of the splitting element 26, specifically, at four corners on the first surface 261.

Illumination light that has passed through the opening of the diaphragm 13 enters the prism 25 from the first surface 251, reflects off the fourth surface 254, penetrates the second surface 252, and then travels to the deflection unit 30 through the hole 2621 of the splitting element 26. The angle of incidence θ₅ of the illumination light with respect to the fourth surface 254 is 37.0 degrees, which is larger than the critical angle (34.6 degrees) of the material of the prism 25. Thus, the fourth surface 254 satisfies the total reflection condition.

According to the present exemplary embodiment, h₁=0.80 mm, h₂=1.26 mm, θ₁=60.0 degrees, θ₂=29.5 degrees, θ₃=16.5 degrees, and θ₄=30.0 degrees, and hence the values of both sides of expression (2) are 1.57. Thus, the diameter of the illumination light is enlarged by the first surface 251 and the second surface 252 of the prism 25. According to the present exemplary embodiment, the Brewster's angle for the material of the prism 25 is 60.4 degrees, resulting in θ_{B}−θ₁=0.4 degrees, which satisfies the conditional expression (4).

Partial illumination light from the first surface 251 of the prism 25 does not penetrate but reflects off the second surface 252 of the prism 25, penetrates the third surface 253, exits from the prism 25, and then enters the light receiving unit for light source 50.

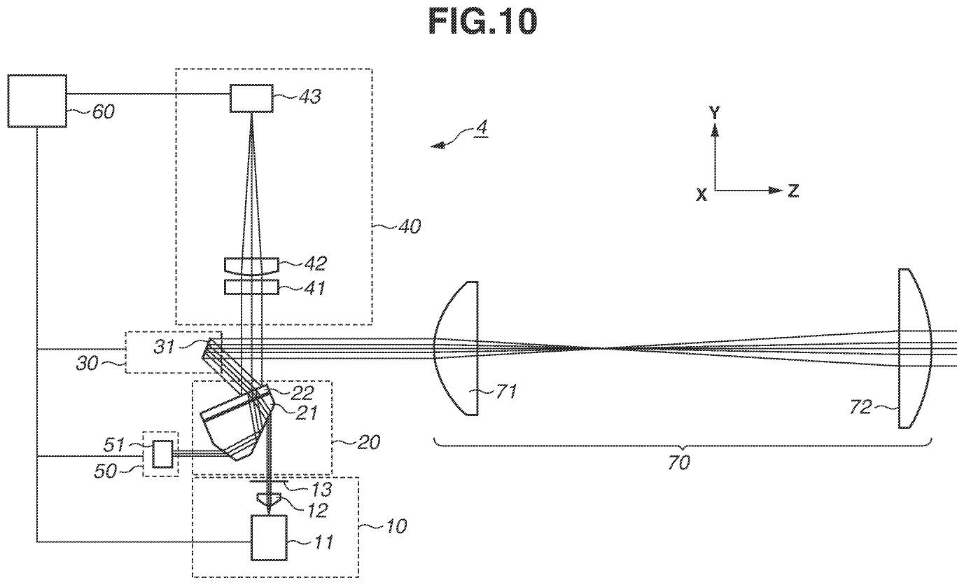

A fourth exemplary embodiment will be described. FIG. 10 schematically illustrates the main portion of an optical apparatus 4 in a cross-section (YZ cross-section) with the optical axis of the optical apparatus 4 according to the fourth exemplary embodiment of the present invention. The optical apparatus 4 according to the present exemplary embodiment differs from the optical apparatus 1 according to the first exemplary embodiment in that an optical system 70 is disposed between the deflection unit 30 and an object (not illustrated). The other configurations are similar to those of the optical apparatus 1 according to the first exemplary embodiment, and redundant descriptions thereof will be omitted.

The optical system 70 is a telescope that enlarges the diameter of illumination light from the deflection unit 30 and reduces the diameter of reflected light from the object, simultaneously. The optical system 70 according to the present exemplary embodiment includes a plurality of optical elements (lenses) each with a refractive power, and totally forms an afocal system with no refractive power. More specifically, the optical system 70 includes a first lens 71 and a second lens 72, both of which are positive lenses, disposed in the order near the deflection unit 30 toward the object. The configuration of the optical system 70 is not limited thereto but may include three or more lenses.

The drive mirror 31 according to the present exemplary embodiment is disposed at the position of the entrance pupil of the optical system 70. The absolute value of the optical magnification (lateral magnification) β of the optical system 70 according to the present exemplary embodiment is greater than 1 (|β|>1). This configuration makes the deflection angle of the principal ray of the illumination light emitted from the optical system 70 smaller than the deflection angle of the principal ray of the illumination light that is deflected by the drive mirror 31 to enter the optical system 70, thus improving the resolving power in detecting objects.

Illumination light from the light source unit 10 is deflected by the deflection unit 30 through the light guide unit 20, and the diameter of the illumination light is enlarged by the optical magnification β times by the optical system 70, and then illuminates an object. The diameter of reflected light from the object is reduced by the optical magnification 1/β times by the optical system 70. Subsequently, the reflected light is deflected by the deflection unit 30, and then reaches the light receiving unit 40.

The disposition of the optical system 70 between the object and the deflection unit 30 enables expansion of the diameter of illumination light not only by the light guide unit 20 but also by the optical system 70. This reduces the spreading angle of the illumination light further by further increasing the diameter of the illumination light, ensuring sufficient illuminance and resolving power even if the object 100 exists at a distant place. The expansion of the pupil diameter with the optical system 70 enables taking in a larger quantity of reflected light from the object, making it possible to improve measurable distance and distance measurement accuracy.

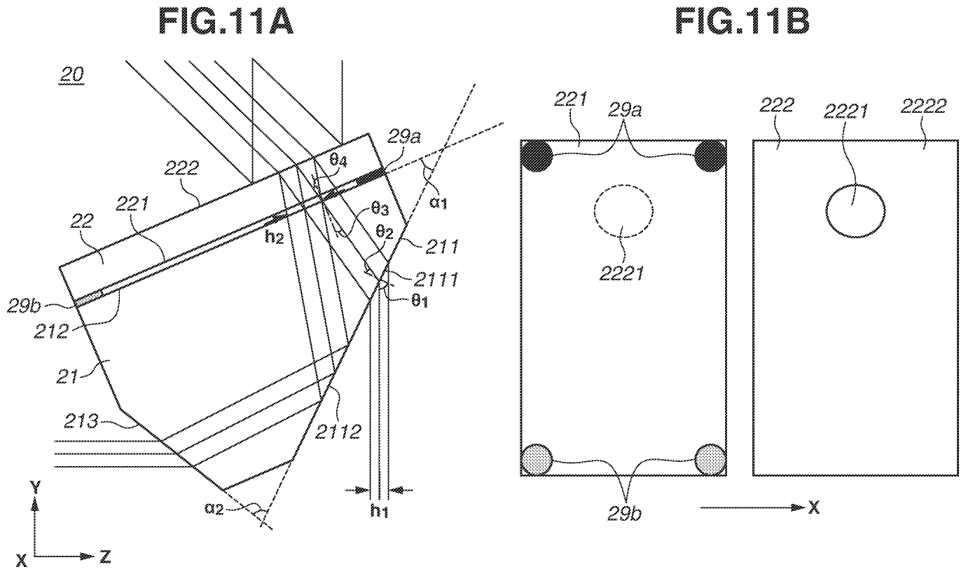

A fifth exemplary embodiment will be described. FIGS. 11A and 11B schematically illustrate the main portion of the light guide unit 20 included in an optical apparatus according to the fifth exemplary embodiment. FIG. 11A illustrates the cross-section (YZ cross-section) perpendicular to each optical surface of the light guide unit 20, and FIG. 11B illustrates the first surface 221 and the second surface 222 of the splitting element 22 viewed from the normal direction. The optical apparatus according to the present exemplary embodiment differs from the optical apparatus 1 according to the first exemplary embodiment only in configuration of fixing members to fix the prism 21 and the splitting element 22 to each other. The other configurations are similar to those of the optical apparatus 1 according to the first exemplary embodiment, and redundant descriptions thereof will be omitted.

Some properties of light emitted from the light source 11 change with temperatures. For example, the oscillation wavelength of a semiconductor laser device varies with temperatures. More specifically, the oscillation wavelength changes (shifts) to longer wavelengths with higher temperatures, and to shorter wavelengths with lower temperatures. If such a wavelength shift occurs, the angle of refraction θ₄ will change at the second surface of the prism 21 from which illumination light from the light source 11 exits. For example, even if each member of the optical apparatus has undergone position adjustment in the production, optical paths of illumination light and reflected light can change with temperature variation, decreasing distance measurement accuracy. There is a conceivable method of enlarging the light receiving surface of the light receiving element 43 to prevent the decrease in quantity of the received light caused by a positional shift of reflected light. However, the enlargement of the light receiving surface of light receiving element 43 would create noise in output information if the light receiving surface is exposed to undesirable light such as sunlight.

According to the present exemplary embodiment, first fixing members 29a and second fixing members 29b are employed as the fixing members 29 to fix the prism 21 and the splitting element 22 to each other. The first fixing members 29a and the second fixing members 29b are different in coefficient of linear expansion from each other. According to the present exemplary embodiment, the coefficient of linear expansion of the first fixing members 29a is smaller than that of the second fixing members 29b. This allows counterclockwise rotation of the prism 21 in the YZ cross-section illustrated in FIG. 11A as the environmental temperature rises higher, correcting the decrease in the angle of refraction θ₄ of the illumination light.

According to the present exemplary embodiment, the prism 21 is fixed with each fixing member so that the prism 21 can rotate in the YZ cross-section due to temperature variation, i.e., about an axis parallel to the X-direction. However, the method is not limited thereto. In other words, the rotation axis of the prism 21 with temperature variation may be not parallel to the X-direction. However, to sufficiently correct the decrease in the angle of refraction θ₄ of the illumination light, the prism 21 is fixed so that the prism 21 can rotate about an axis in a direction that contains an X-direction component (in a direction that contains a component parallel to each optical surface).

According to the present exemplary embodiment, as illustrated in FIG. 11B, the first fixing members 29a are provided at two corners on one end of the first surface 221 of the splitting element 22 (the second surface 212 of the prism 21) in a direction perpendicular to the X-direction, and the second fixing members 29b are provided at two corners on the other end. However, instead of providing two first fixing members 29a and two second fixing members 29b, one first fixing member 29a along with two second fixing members 29b or one second fixing member 29b along with two first fixing member 29a may be provided. More specifically, when the first fixing members 29a and the second fixing members 29b are projected on the plane perpendicular to each optical surface, the first fixing members 29a are positioned on one side with respect to the illumination light, and the second fixing members 29b on the other side with respect to the illumination light.

The inequality relationship between the coefficient of linear expansion of the first fixing members 29a and that of the second fixing members 29b may be determined according to the incident direction (the disposition of each member) of the illumination light with respect to the prism 21, because whether the angle of refraction θ₄ increases or decreases due to temperature variation depends on the incident direction. According to the present exemplary embodiments, the prism 21 is fixed to the splitting element 22 with the first fixing members 29a and the second fixing members 29b, and illumination light from the light source 11 is refracted counterclockwise at the first surface 211 of the prism 21 and is further refracted counterclockwise at the second surface 212 of the prism 21. The prism 21 therefore is configured to rotate counterclockwise with temperature variation, as described above.

In the present exemplary embodiment, the first fixing members 29a are a bonding member with a linear expansion coefficient of 1.00×10⁻⁵, and the second fixing members 29b are a bonding member with a linear expansion coefficient of 3.20×10⁻⁴. The first fixing members 29a and the second fixing members 29b each have a thickness of 0.45 mm. The interval between the first fixing members 29a and the second fixing members 29b on the first surface 221 is 12 mm.

As the temperature of the light source 11 rises from 22 to 50 degrees Celsius, the oscillation wavelength varies from 905 to 920 nm, and the angle of refraction θ₄ decreases by 0.02 degrees. This causes a difference of 0.006 mm in thickness between the first fixing members 29a and the second fixing members 29b, rotating the prism 21 counterclockwise by 0.03 degrees in the YZ cross-section. As a result, the angle of refraction θ₄ can be corrected up to a level significantly identical to the angle θ₄ before the temperature variation. Thus, this reduces the decrease in the quantity of received light due to the wavelength shift caused by the temperature variation of the light source 11.

### [On-Vehicle System]

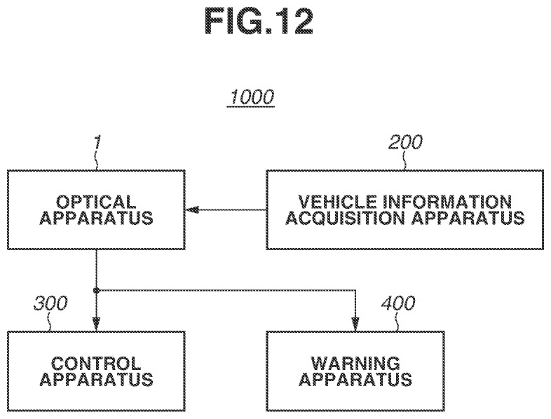

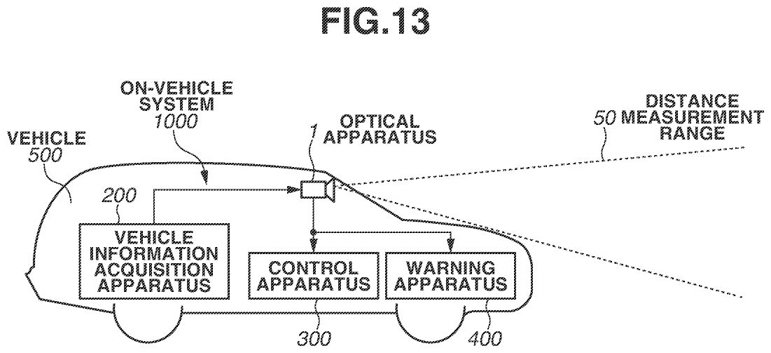

Another exemplary embodiment will be described. FIG. 12 is a functional block diagram illustrating the configuration of an on-vehicle system (driving assistance apparatus) 1000 including the optical apparatus 1 according to the present exemplary embodiment. The on-vehicle system 1000 supported by a moving body (moving apparatus), such as an automobile (vehicle), is an apparatus to assist the driving (control) of the vehicle based on distance information about an object such as an obstacle or a walker around the vehicle acquired by the optical apparatus 1. FIG. 13 schematically illustrates a vehicle 500 including the on-vehicle system 1000. FIG. 13 illustrates a case where the distance measurement range (detection range) of the optical apparatus 1 is set to the anterior side of the vehicle 500. However, the distance measurement range may be set to the posterior or lateral side of the vehicle 500.

As illustrated in FIG. 12, the on-vehicle system 1000 includes the optical apparatus 1, a vehicle information acquisition apparatus 200, a control apparatus (electronic control unit (ECU)) 300, and a warning apparatus (warning unit) 400. In the on-vehicle system 1000, the control unit 60 included in the optical apparatus 1 has the functions of a distance acquisition unit (acquisition unit) and a collision determination unit (determination unit). However, the on-vehicle system 1000 may include the distance acquisition unit and the collision determination unit separately from the control unit 60. These units may be provided outside the optical apparatus 1 (e.g., inside the vehicle 500). Alternatively, the control apparatus 300 may be used as the control unit 60.

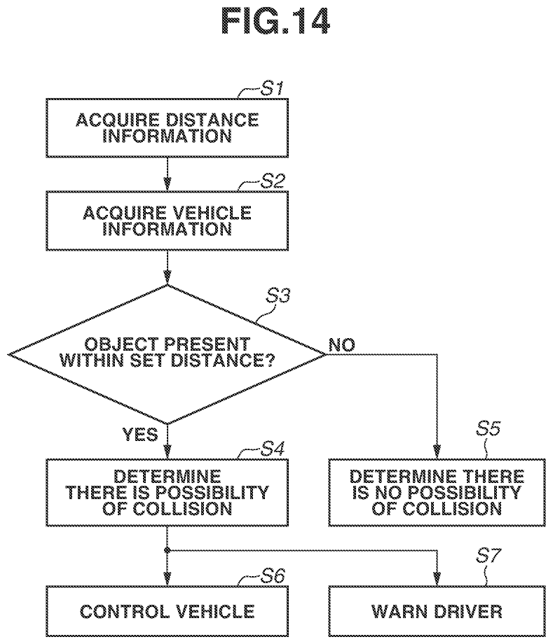

FIG. 14 is a flowchart illustrating an example of an operation of the on-vehicle system 1000 according to the present exemplary embodiment. Operations of the on-vehicle system 1000 will be described with reference to the flowchart.

In step S1, the control unit 60 acquires distance information about the object based on a signal output by the light receiving unit 40, which has received reflected light from an object around the vehicle, the object of which has been illuminated by the light source unit 10 of the optical apparatus 1. In step S2, the vehicle information acquisition apparatus 200 acquires vehicle information including the vehicle speed, yaw rate, and steering angle of the vehicle. In step S3, the control unit 60 determines whether the distance to the object falls within a preset distance range using the distance information acquired in step S1 and the vehicle information acquired in step S2.

This makes it possible to determine whether the object exists within the set distance around the vehicle to determine the possibility of a collision between the vehicle and the object. Steps S1 and S2 may be performed in reverse order of the above-described order, or performed in parallel. If an object exists within the set distance (YES in step S3), the processing proceeds to step S4. In step S4, the control unit 60 determines that “there is a possibility of a collision”. If no object exists within the set distance (NO in step S3), the processing proceeds to step S5. In step S5, the control unit 60 determines that “there is no possibility of a collision”.

If the control unit 60 determines that “there is a possibility of a collision”, the control unit 60 notifies the control apparatus 300 and the warning apparatus 400 of the determination result (transmits the determination result thereto). In step S6, the control apparatus 300 controls the vehicle based on the determination result by the control unit 60. In step S7, the warning apparatus 400 warns the user (driver) of the vehicle based on the determination result by the control unit 60. The control unit 60 notifies at least one of the control apparatus 300 or the warning apparatus 400 of the determination result.

The control apparatus 300 controls the vehicle by generating control signals, for example, to apply brakes, release the accelerator, turn the steering wheel, and generate a braking force on each wheel to reduce the power of the engine and motor. The warning apparatus 400 warns the driver, for example, by emitting an alarm sound, displaying alarm information on the screen of the car navigation system, and vibrate the seat belt or steering wheel.

The on-vehicle system 1000 according to the present exemplary embodiment enables performing object detection and distance measurement through the above-described processing, making it possible to avoid a collision between the vehicle and the object. In particular, the on-vehicle system 1000 equipped with the optical apparatus 1 according to the exemplary embodiments provides high distance measurement accuracy, making it possible to perform object detection and collision determination with high accuracy.

Although, in the present exemplary embodiment, the on-vehicle system 1000 serves as driving assistance (collision damage reduction), the method is not limited thereto. The on-vehicle system 1000 may serve as cruise control (including all-vehicle-speed tracking function) and automatic driving control. The on-vehicle system 1000 can be applied not only to vehicles such as automobiles but also to moving bodies such as boats and ships, aircraft, and industrial robots. In addition, the on-vehicle system 1000 can be applied not only to moving bodies but also to Intelligent Transport Systems (ITS), monitoring systems, and other various apparatuses utilizing object recognition.

The on-vehicle system 1000 and the moving apparatus 500 may include a notification apparatus (notification unit) to notify, if the moving apparatus 500 collides with an obstacle, the manufacturer (maker) of the on-vehicle system 1000 and the sales agency (dealer) of the moving apparatus 500 of the collision. For example, such an apparatus that transmits information (collision information) about the collision between the moving apparatus 500 and the obstacle to a preset external notification destination by e-mail can be employed as the notification apparatus.

This configuration to automatically notify of the collision information via the notification apparatus allows quickly taking measures such as inspection or repair after a collision occurs. Notification destinations of the collision information may include an insurance company, a medical institution, police, and any other destinations set by the user. The notification apparatus may be configured to notify the notification destination of not only the collision information but also failure information on each portion and consumption information on consumables. The presence or absence of a collision may be detected with the distance information acquired based on the output from the above-described light receiving unit 40, or via other detection units (sensors).

### Other Exemplary Embodiment

While the present invention has specifically been described based on the above-described exemplary embodiments, the present invention is not limited thereto but can include various combinations, modifications, and changes in diverse ways within the scope of the appended claims.

For example, other optical elements may be disposed in the optical path between the light guide unit 20 and the deflection unit 30. However, to more reduce the occurrence of the above-described undesirable light, nothing is disposed in the optical path between the light guide unit 20 and the deflection unit 30, as in each of the above-described exemplary embodiment. In other words, a configuration may be employed that illumination light from the transmissive region of the splitting element 22 is incident on the drive mirror 31 without travelling via the other surfaces.

Although the individual members are integrated (integrally held) in each exemplary embodiment, they may be separately configured. For example, the light source unit 10 and the light receiving unit 40 are attachable to and detachable from the light guide unit 20 or the deflection unit 30. In this case, a holding member (housing) to hold each member is provided with a connecting portion (binding portion) to connect to each other. For this configuration, to improve the positioning accuracy between the light source unit 10 and the light guide unit 20, a diaphragm 13 may be provided in the light guide unit 20 and held by a holding member that holds the light guide unit 20.

Although a parallel plate is used as the splitting element 22 in each exemplary embodiment, the first surface 221 and the second surface 222 may be non-parallel to each other. However, as described above, the angle formed between the first surface 221 and the second surface 222 is narrow to facilitate the production of the light guide unit 20. Besides, although the optical surface (second surface 222) (nearer to the deflection unit 30) of the splitting element 22 opposite to the prism 21 has a reflective region in each exemplary embodiment, the first surface 221 of the splitting element 22 may have a reflective region. However, to reduce the influence of scratches and foreign matter on each optical surface, the second surface 222 of the splitting element 22 has a reflective region as in each exemplary embodiment.

Although each optical surface of the prism 21 and the splitting element 22 is flat, at least one optical surface may be a curved surface. However, each optical surface is flat to facilitate the production of the light guide unit 20. Although, in the fifth exemplary embodiment, two fixing members with different coefficients of linear expansion from each other are employed, three or more fixing members with different coefficients of linear expansion from one another may be employed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-022216, filed Feb. 13, 2020, which is hereby incorporated by reference herein in its entirety.

What is claimed is:

1. An optical apparatus comprising:
a deflection unit configured to deflect illumination light from a light source to scan an object and deflect reflected light from the object; and
a light guide unit configured to guide the illumination light from the light source to the deflection unit and guide the reflected light from the deflection unit to a light receiving element,
wherein the light guide unit includes a first optical element to change a diameter of the illumination light from the light source, a second optical element including a passage region through which the illumination light from the first optical element passes and a reflective region to reflect the reflected light from the deflection unit, and at least one fixing member fixing the first optical element and the second optical element to each other.

2. The optical apparatus according to claim 1, wherein the at least one fixing member fixes the first optical element and the second optical element to each other outside the passage region.

3. The optical apparatus according to claim 1, wherein the at least one fixing member includes a first fixing member and a second fixing member, a coefficient of linear expansion of the first fixing member being different from a coefficient of linear expansion of the second fixing member.

4. The optical apparatus according to claim 1, wherein the at least one fixing member is a bonding member bonding the first optical element and the second optical element to each other.

5. The optical apparatus according to claim 1, wherein a following conditional expression is satisfied:
t<1.0 mm,
where t is a distance between the first optical element and the second optical element.

6. The optical apparatus according to claim 1, wherein the first optical element includes a first surface on which the illumination light from the light source is incident, and a second surface from which the illumination light from the first surface exits toward the second optical element.

7. The optical apparatus according to claim 6, wherein the illumination light from the first surface is incident on the second surface, the illumination light not travelling via any other surface.

8. The optical apparatus according to claim 6, wherein, in a cross-section perpendicular to the first surface and the second surface, a diameter of the illumination light emitted from the second surface is larger than a diameter of the illumination light incident on the first surface.

9. The optical apparatus according to claim 6, wherein the first optical element includes a third surface on which light reflected by at least one of the second surface or the passage region is incident.

10. The optical apparatus according to claim 9, wherein the first surface reflects the light reflected by the at least one of the second surface or the passage region and then guides the light to the third surface.

11. The optical apparatus according to claim 6, further comprising a light receiving unit for light source configured to receive the light reflected by at least one of the second surface or the passage region.

12. The optical apparatus according to claim 6, wherein a following conditional expression is satisfied:
−10<θ_{B}−θ₁<10,
where θ₁ (degrees) is an angle of incidence of the illumination light with respect to the first surface, and θ_{B} (degrees) is a Brewster's angle for the first surface, in a cross-section perpendicular to the first surface and the second surface.

13. The optical apparatus according to claim 1, wherein the reflective region is on an optical surface of the second optical element opposite to the first optical element.

14. The optical apparatus according to claim 1, wherein the illumination light from the passage region enters the deflection unit, the illumination light not travelling via any other surface.

15. The optical apparatus according to claim 1, further comprising a control unit configured to acquire distance information on the object based on an output of the light receiving element.

16. An on-vehicle system comprising the optical apparatus according to claim 1, wherein a possibility of a collision between a vehicle and the object is determined based on distance information on the object obtained by the optical apparatus.

17. The on-vehicle system according to claim 16, further comprising a control apparatus configured to output a control signal to generate a braking force in the vehicle in response to it being determined that there is a possibility of a collision between the vehicle and the object.

18. The on-vehicle system according to claim 16, further comprising a warning apparatus configured to warn the driver of the vehicle in response to it being determined that there is a possibility of a collision between the vehicle and the object.

19. The on-vehicle system according to claim 16, further comprising a notification apparatus configured to notify an outside of information about the collision between the vehicle and the object.

20. A moving apparatus comprising the optical apparatus according to claim 1, wherein the moving apparatus is movable with the optical apparatus held on the moving apparatus.
